(19) United States
(12) Patent Application Publication
(10) Pub. No.: US 2021/0308604 A1
(43) Pub. Date: Oct. 7, 2021

(54) FLUID TREATMENT SYSTEM HAVING CONCENTRIC CHAMBERS

(71) Applicant: Stonehouse Innovations, LLC, Milwaukee, WI (US)

(72) Inventor: Hensley Foster, Jackson, WI (US)

(21) Appl. No.: 17/220,096

(22) Filed: Apr. 1, 2021

Related U.S. Application Data
(60) Provisional application No. 63/003,388, filed on Apr. 1, 2020.

(51) Int. Cl. B01D 29/54; B01D 29/15

(52) U.S. Cl. CPC B01D 29/54; B01D 2201/30; B01D 2201/32; B01D 29/15

(57) ABSTRACT

A system and method for treating fluid by providing a series of concentric chambers, tanks or tubes so that a fluid flow and treatment efficiency is maximized while size, complexity and cost of manufacture and operation is reduced. In one aspect, a generally non-turbulent fluid flow is received and directed in a radial sequential direction through the series of chambers. Each chamber is configured to house a filter assembly or media that provides a level of treatment for the fluid flow while directing the fluid toward a subsequent concentric filtration chamber. The last sequential chamber directs the fluid flow toward a fluid outlet and reduces the turbulence of the flow generated during the filtration process. The system can be configured to direct the fluid flow in inward or outward radial directions according to various arrangements and during filtration or back flushing operations.

### CROSS-REFERENCE TO RELATED APPLICATIONS

This application claims priority to U.S. Provisional Patent Application Ser. No. 63/003,388 titled “FLUID TREATMENT SYSTEM HAVING CONCENTRIC CHAMBERS” filed on Apr. 1, 2020; the disclosure of which is expressly incorporated herein.

### FIELD OF THE INVENTION

The present invention is directed to a system for treatment of gas and fluid flows, such as treatment for air, water or other liquids, and more particularly, to a system for fluid treatment which provides multiple stages of fluidic treatment. As used herein, the term “fluid” is directed to substances that flow regardless of the state of the substance as being in a liquid state or a gas state.

### BACKGROUND OF THE INVENTION

Various fluid treatment systems, such as air and water purification systems, are well known. Such systems sometimes include multiple stages that are present to apply various levels of treatment, such as from coarse filtration to fine filtration for water flows. Such systems are commonly tailored or otherwise configured to satisfy demands specific to particular applications in each of residential, industrial, and agricultural applications. For instance, in some environments, deployment of the gas or water filtration systems may be configured to remove heavy metals such as lead and iron from the fluid flows as well as excess chemical concentrations such as nitrates, phosphates, fluorides, etc. from the fluid flows to output potable water or gases that are less polluted with particulate matter. Other applications, such as agricultural or farming operations, may tolerate fluid throughputs of desired levels of phosphates and nitrates for crop irrigation applications.

The various stages of fluid treatment are typically accomplished by individual tanks and piping that directs flow sequentially into and out of each treatment tank and exposure of the fluid flow to or through discrete filter media associated with each containment container. However, such approaches produce large footprints associated with the system and often requires extensive and complex piping. Moreover, each individual tank has to be constructed in a heavy-duty manner, with walls of greater thickness, to accommodate the respective volumes, flow rates, and fluid pressures involved in communicating the fluid flows sequentially through the filter assemblies. Connecting pipes, valves and the like also typically require such heavy-duty construction. This results in systems of undesirably greater size, complexity and cost.

The sequential fluid flow through various discrete filter and filter housing assemblies to achieve the desired levels of filtration also detract from the ability of once deployed systems to be economically reconfigured to satisfy changes associated with the quality of source fluid flows. The dynamic conditions associated with the intake fluid flow conditions or quality can result in situations wherein a previously configured filtration system is rendered no longer suitable for the given application and/or to achieve the desired output quality of quantity. For instance, if greater particulate matter becomes present in the intake fluid flow, initial filtration devices may become prematurely soiled or spoiled and create pressure differentials across the discrete filter assemblies that thereby lower the ability of the resultant system to generate the previously provided fluid flow volumes and rates. The same is commonly mitigated by increasing the frequency associated with service and/or cleaning of soiled filters and thereby increases the end user costs associated with maintaining the desired operation of the filtration system.

Accordingly, there is a need for fluid treatments that mitigate or eliminate one or more of the foregoing disadvantages.

### SUMMARY OF THE INVENTION

The present invention provides a system for treating fluid, such as air or water other fluids or liquids, by providing a series of chambers, tanks or tubes arranged concentrically with respect to one another, so that fluid flow and treatment efficiency is maximized while size, complexity and cost associated with formation of the desired treatment system are reduced. In one aspect, fluid preferably in a laminar or more linear flow is received and directed radially sequentially to the series of chambers. Each chamber, in turn, can provide a level of treatment for the fluid flow while directing the fluid to the next concentric chamber. The last chamber in the arrangement can re-direct the fluid flow toward a non-turbulent flow. The system can direct the flow from outer to inner chambers or from inner to outer chambers according to various arrangements and/or depending upon the desired filtration and/or filtration system operational objectives.

Accordingly, in one aspect, the invention provides a vessel composed of multiple concentric chambers that have a linear or non-turbulent influent (in) of gases, liquids, gases entrained in liquids, or semi-solids that re-directs flow from one chamber to the next using radial flow; then recombining into effluent (out) using linear or generally non-turbulent or laminar flows. This can create larger areas for specialized treatment as the gas, liquid or semi-solid particulates as the fluid flow progresses through the vessel.

In one aspect, the outer tube of the system can be have a greater wall thickness, or heavier duty rating, serving as a pressure vessel, while interior chambers can be lesser in thickness. Also, there is no piping from chamber to chamber as the flow of liquid is directed radially into and out of the adjoining concentric filter chambers via holes which could also form a filter media retention barrier for those application wherein the filter media is provided in a granular rather than planar form factor. As a result, the system can treat and process more fluids whether gas or liquid states, in a smaller cubic footprint than previous systems, thereby yielding fewer materials and parts used, and thereby providing a cost benefit. This can be accomplished by integrating concentric tanks that flow in radial directions between adjacent tanks. Media can fill cavities to 100% aside from the interstices associated therewith, thereby improving contact time and area and residence time of the fluid flow with the filtration media over previous singular linear flow cartridge filter approaches.

The radially directed flow patterns associated with connecting adjacent tanks are engineered and optimized. Shapes, sizes, locations, and total area of holes in the chamber partition walls are optimized to improve fluid flow dwell times associated with discrete chambers and the filter media associated therewith. The system can be easier to maintain and service as media can be flushed out of cavities and new media is introduced when the top is removed. The system can increase/decrease capacity of the unit without adding additional units in parallel simply by increasing diameters of treatment tubes that make up the system and or manipulation of the media associated therewith. In other words, the process, flow directions, treatment sequence and the like need not change with only dimensions of the system changing to accommodate dynamic changes to the inlet flow volume, quality, and/or rate changes.

One aspect of the invention provides a fluid treatment system including: a vessel having an inlet, an outlet and multiple concentric chambers, each chamber providing a stage of fluidic treatment, in which the inlet is configured to receive fluid in a more linear, generally laminar, or generally non-turbulent flow and direct the fluid whether in the gas or liquid states or combinations thereof, between the concentric chambers, in which each chamber of the concentric chambers is configured to receive the fluid in a radial flow that is circumferential relative to the chamber, and in which the concentric chambers are configured to direct the fluid to the outlet in a generally linear, laminar, or non-turbulent flow.

Another aspect that is useable with one or more of the above aspects may provide a method for treating fluid, including: providing a vessel with an inlet, an outlet and multiple concentric chambers; receiving fluid at the inlet in a linear flow and directing the fluid to the concentric chambers; receiving the fluid at each chamber of the concentric chambers in a radial flow that is circumferential relative to the chamber; providing a stage of fluidic treatment at each chamber; and directing the fluid from the concentric chambers to the outlet.

Other aspects, objects, features, and advantages of the invention will become apparent to those skilled in the art from the following detailed description and accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout.

FIG. 1 is a cutaway schematic view of a fluid treatment system in accordance with the present invention;

FIG. 2 is an exemplar schematic top view of multiple concentric chambers present in the system of FIG. 1;

FIG. 3 is an exemplar cross-sectional view of portions of the concentric chambers or filter rings of FIG. 2;

FIG. 4 is an exemplar cross-sectional view of an inner cap for directing and distributing the fluid flow in the desired sequence to the respective concentric chambers of FIGS. 2 and 3;

FIG. 5 is an exemplar top plan view of the inner cap of FIG. 4;

FIG. 6 is an exemplary cutaway schematic view of a fluid treatment system which may be suitable for treating wastewater or other fluid flows in accordance with another aspect of the present invention; and

FIG. 7 is an exemplary cutaway schematic view of a fluid treatment system which may be suitable for treating fluid flows and operation of a filtration system according to another aspect of the invention.

### DETAILED DESCRIPTION OF THE DRAWINGS

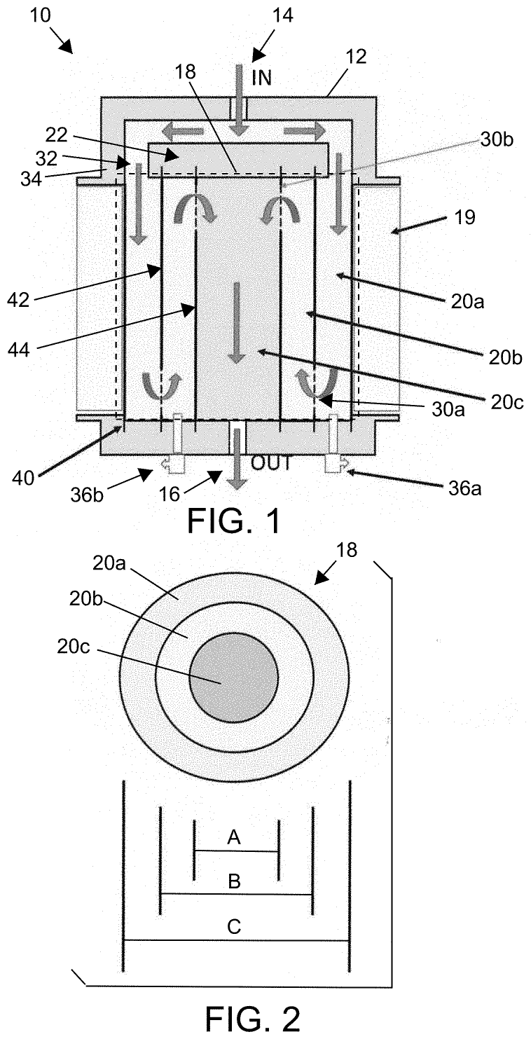

Referring now to the drawings, where like numerals refer to like parts throughout, and specifically to FIG. 1, a cutaway schematic view of a fluid treatment system 10 is provided in accordance with an aspect of the application. The fluid treatment system 10 could be for treating fluid, such as water regardless of source, wastewater, runoff, etc.; or gas flows such as air or the like, by providing a series of chambers, tanks or tubes arranged concentrically with respect to one another, so that fluid flow and treatment efficiency is maximized while size, complexity and cost can be reduced, as described herein. The fluid treatment system 10, whether employed to filter gas or liquid fluid flows, can comprise a vessel 12 having an inlet 14, an outlet 16 and a plurality of concentric chambers 18. In one aspect, the plurality of concentric chambers can comprise three generally cylindrical chambers, including an outer chamber 20a, a middle chamber 20b and an inner chamber 20c, as illustrated in FIG. 1. However, in other aspects, greater or lesser numbers of chambers can be present. In addition, an insulation layer 19 can be configured to surround the plurality of concentric chambers 18 to provide improved environmental thermal control associated with operation of system 10.

Each chamber 20 can provide a stage of fluidic treatment or level, such as from coarse filtration to fine filtration. For example, in the treatment of water, the outer chamber 20a could comprise a pre-filter stage, the middle chamber 20b could comprise a filter for heavy metals, biocide and the like, and the inner chamber 20c could comprise a stage for disinfection, carbon treatment and the like. Moreover, walls 40 of the outer chamber 20a can be greater in thickness, or heavy-duty, serving as a pressure vessel, while walls 42 and 44 of the middle and inner chambers 20b and 20c, respectively, can be comparatively thinner than wall 40. Such walls 40 of the outer chamber 20a could be embedded in silicone filled gullies to provide such greater thickness and/or strength and to provide the desired fluid flow direction in a radial direction and in a controlled manner through respective walls 40, 42, 44 in a desired manner and without bypassing the discrete filter means associated with discrete chambers 20a, 20b, 20c.

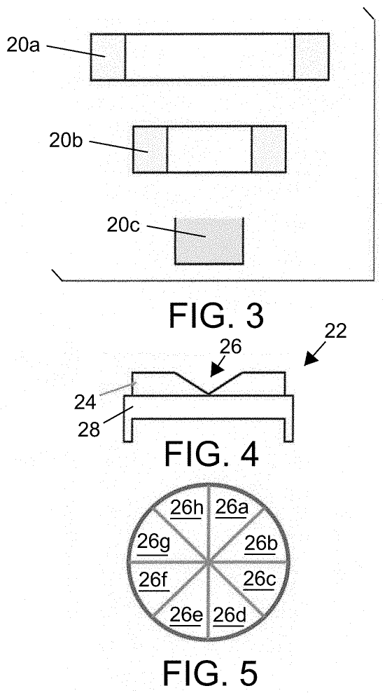

With additional reference to the exemplar top and cross-sectional portion views of FIGS. 2 and 3, respectively, each chamber 18 can be arranged concentrically. As used herein, “concentrically” refers to a geometric property in which two or more objects are arranged co-axially so that they have the same center or axis. Accordingly, each chamber 20 can be arranged to share a common center with smaller chambers being nested within larger chambers another. The outer chamber 20a could have a diameter of “A,” which could be at least twenty-four (24) inches; the middle chamber 20b could have a diameter of “B,” which could be at least eighteen (18) inches; and the inner chamber 20c could have a diameter of “C,” which could be at least twelve (12) inches, each in concentric relation to one another. As a result, outer chambers 18, such as outer chamber 20a and middle chamber 20b, can form concentric rings around inner chambers 20c, such as middle chamber 20b and inner chamber 20c, respectively. It is appreciated that the relative dimensions associated with chambers 18 are merely exemplary as well at the respective ratios therebetween. That is, it is appreciated that the relative dimensions between discrete chambers 18 and the relative dimensions therebetween could be provided in values and ratios other than those provided above.

The inlet 14 can be configured to receive fluid in a generally linear, generally laminar, or generally non-turbulent flow as illustrated by flow arrows in FIG. 1. As used herein, a “linear flow” refers to a flow of fluid in substantially one direction and whose relative degree of turbulence or laminar characteristics may change as the flow progresses through system 10 between inlet 14 and outlet 16. Upon entry of system 10, the fluid flow can then be directed in a radial direction toward one or more of the plurality of concentric chambers 18. As used herein, a “radial flow” refers to a flow of fluid in multiple directions including generally opposing directions albeit at crossing directions relative to the longitudinal axis defined by the orientation of the respective chambers 18. At least a portion of the fluid flow through system 10 is directed in a radial direction as the discrete flows progress in the direction of the fluid flow between adjacent chambers 18. The plurality of concentric chambers 18, in turn, are configured to then direct the fluid to the outlet 16 in a linear flow.

With additional reference to the cross-sectional and plan views of FIGS. 4 and 5, respectively, in one aspect, for efficiently distributing the fluid from the linear flow to the radial flow, an inner cap 22 can be arranged in cooperation with the inlet 14. The inner cap 22 can comprise an upper surface 24 having a plurality of channels 26, each of which could be substantially “V” shaped with opposing fins, and a lower surface 28 configured to cooperate with an end of the plurality of concentric chambers 18 in a sealing manner, as illustrated in the cross-sectional view of FIG. 4. Accordingly, the inner cap 22 can be configured to distribute the fluid from the inlet 14 in multiple directions which circumferentially surround the plurality of concentric chambers 18, such as at least 8 directions corresponding to channels 26-h, as illustrated in the plan view of FIG. 5. Such a consideration allows the inlet fluid flow to be distributed in a generally uniform manner across the cross-sectional area provided by any filter media associated with chamber 20a.

Each chamber 20 can be configured to circumferentially receive the fluid through discrete opens or holes 30 formed in partition walls between discrete chambers 20a, 20b, and 20c and which preferably form a media retention barrier. In addition, each chamber can be configured to receive the fluid only through an upper portion or lower portion of the chamber 20. Preferably, the holes 30 associated with adjacent partition walls are disposed at opposite axial ends of the discrete partition walls such that fluid flows directed into the discrete chambers is directed in an axial direction through the filter media associated with the discrete chamber 20 before progressing the next respective chamber 20 of system 10.

By way of example, fluid entering the inlet 14 in a linear flow can be redirected radially by the inner cap 22 in a radial flow that is directed in an outward radial direction toward the circumferential area defined by the largest of the plurality of concentric chambers 18. Accordingly, the fluid can first be directed to the outer chamber 20a only through an upper portion formed by a circumferential gap 32 between the inner cap 22 and outer wall 34 of the vessel 12. Then, the fluid can traverse through the axial length of the outer chamber 20a, providing a first stage or level of fluidic treatment associated with a filter media associated therewith. Then, the fluid can be directed to the middle chamber 20b, with the middle chamber 20b receiving the fluid only through holes 30a at a lower portion of the chamber (opposite the upper portion formed by the gap 32) in a radial flow that is circumferential relative to the adjacent chamber. Then, the fluid, whether in a gas or liquid state, can traverse through the length of the middle chamber 20b, and through, over or across a treatment media associated therewith and providing a second stage or level of fluidic treatment. Then, the fluid can be directed to the inner chamber 20c, with the inner chamber 20c receiving the fluid only through holes 30b, which could comprise a micro metal or plastic screen or the like, at an upper portion of the chamber (opposite the holes 30a) in a radial flow that is circumferential relative to the chamber. Then, the fluid can traverse through the length of the inner chamber 20c, providing a third stage or level of fluidic treatment via interaction of the fluid flow with, across, over, or through a filter media associated therewith. Finally, from a lower portion of the inner chamber 20c (opposite the holes 30b and the gap 32), the inner chamber 20c, and the plurality of concentric chambers 18 as a whole, can direct the fluid to the outlet 16 in a linear flow.

It is appreciated that in another aspect, the direction of flow through system 10 could be reversed such that the inlet 14 could operate as the outlet, and the outlet 16 could operate as the inlet. Such a consideration provides greater surface areas and dwell times associated with the interaction of the fluid flow as it progresses through filter system 10 in the outward radial direction. For instance, if a fluid flow include low amounts of suspended solids but relative higher amounts of dissolved or entrained materials, the progressively larger volumes associated with chambers 20a, 20b, and the filter materials or media associated therewith, can be employed to extract the greater quantity constituents of the fluid flow and the lower volume chambers can be employed to resolve the lesser quantity constituents associated with the fluid flow input character and desired fluid flow output character.

Regardless of the relative radial direction of the fluid flow through system 10, vessel 12 preferable includes one or more valves, bypass passages, or bleeder valves 36 can be arranged with respect to various chambers 20 for selectively releasing at least a portion of the fluid flow associated with one or more of chamber 20 and allowing the relative portion of the fluid flow directed therethrough to bypass one or more of the downstream filtration chambers. For example, an outer chamber valve 36a can be arranged with respect to the outer chamber 20a for selectively releasing fluid from the outer chamber 20a, allowing fluid to bypass the middle and inner chambers 20b and 20c, respectively (when flowing from inlet 14 to outlet 16) but after passage of the fluid flow through the filtration media associated with chamber 20a (when flowing from inlet 14 toward outlet 16). Similarly, a middle chamber valve 36b can be arranged with respect to the middle chamber 20b for selectively releasing fluid from the middle chamber 20b, allowing fluid to bypass the inner chamber 20c (when flowing from inlet 14 to outlet 16). Such valves can be electronically controlled in conjunction with system sensing. Such a consideration allows utilization of system for varied degrees of relative treatment of the fluid flow and utilization of portions of the fluid flow for various activities such as irrigation, greywater uses, and generation of potable water from a single source flow.

Accordingly, a system for treating fluid, such as air or water or other fluid flows, is provided by a series of chambers 20, or tanks or tubes, arranged concentrically with respect to one another, so that fluid flow and treatment efficiency and efficacy is maximized while size, complexity and cost of manufacture and operation is reduced. Fluid flow in a linear flow is received and directed in a radial direction to downstream chambers of the respective series of chambers. Each chamber, in turn, provides a level of treatment for the fluid flow while directing the fluid flow to the next concentric chamber and the filtration appliance or media associated therewith. The last chamber in the arrangement can re-direct the fluid back to a linear flow. However, in other arrangements, the present invention can provide a system for treating other liquids or gases. Also, in other arrangements, the present invention can direct the flow of fluid from inner to outer chambers, instead of from outer to inner chambers as described above with respect to FIG. 1. It is further appreciated that the various chambers, and the radially oriented partitions disposed therebetween, can be employed to generate various relative levels of filtration and/or treatment of the fluid flow such as via exposure to ultraviolet light or the like, and/or exposure to other chemical treatments associated with microorganism abatement.

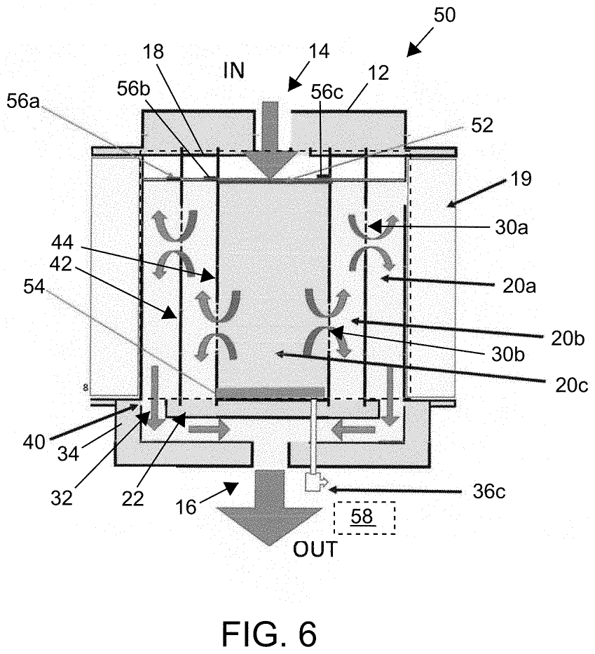

Referring now to FIG. 6, where like numerals refer to like parts throughout, a cutaway schematic view of a fluid treatment system 50 which may be suitable for treating wastewater, well or municipal water, grey water, runoff, or similar liquids or air or other gas flows is provided in accordance with another aspect of the application. In the fluid treatment system 50, gravity can be used to drive the fluid, such as wastewater or mixed gas flows, in a linear flow through the inlet 14 to the plurality of concentric chambers 18, and more specifically, to the inner chamber 20c, with floatable material 52, or lower weight gas molecules when employed for gas filtration, accumulating at the top and residual, semi-solid material 54 or heavier gas molecules accumulating at the bottom. Then, the fluid can traverse through the length of the inner chamber 20c, providing a first stage or level of fluidic treatment, such as a treatment for anoxic water. Then, the fluid can be directed to the middle chamber 20b, with the middle chamber 20b receiving the fluid only through holes 30b at a lower portion of the chamber (opposite the inlet 14) in a radial flow that is circumferential relative to the chamber. Then, the fluid can traverse through the length of the middle chamber 20b, providing a second stage or level of fluidic treatment, such as a first treatment for anerobic water. Then, the fluid can be directed to the outer chamber 20a, with the outer chamber 20a receiving the fluid only through holes 30a, at an upper portion of the chamber (opposite the holes 30b) in a radial flow that is circumferential relative to the chamber. Then, the fluid can traverse through the length of the outer chamber 20a, providing a third stage or level of fluidic treatment, such as such as a second treatment for anerobic water. Finally, from a lower portion of the outer chamber 20a (opposite the holes 30a and the inlet 14), the outer chamber 20a, and the plurality of concentric chambers 18 as a whole, can direct the fluid to the inner cap 22, reversed in orientation relative to FIG. 1, to the outlet 16 in a linear flow. Flow from the outlet 16 may be assisted by a pump 58 as desired.

An inner chamber valve 36c, which may be a dump or recirculate valve, can be arranged with respect to the inner chamber 20c for selectively releasing fluid from the inner chamber 20c, allowing fluid to bypass the middle and outer chambers 20b and 20a, respectively. In addition, float switches 56a-c, can be arranged at the surfaces of fluid in each of the chambers 20a-c, respectively, to sense or detect the level of fluid in each chamber.

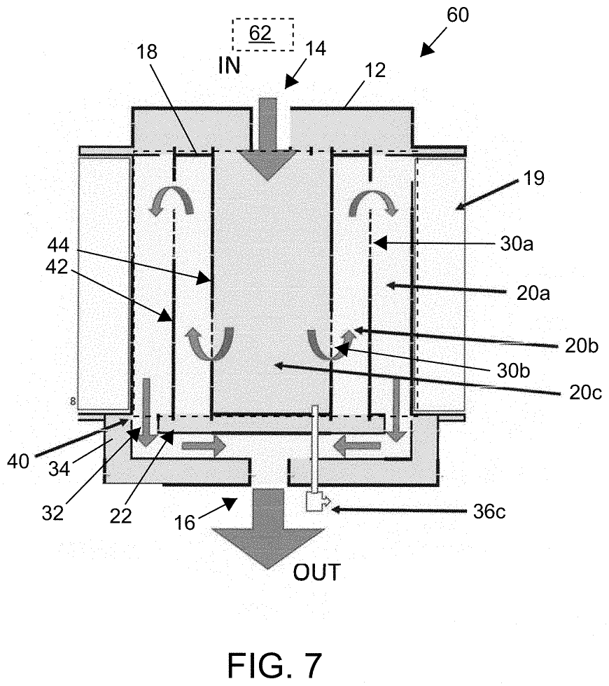

Referring now to FIG. 7, where like numerals refer to like parts throughout, a cutaway schematic view of a fluid treatment system 60 which may be suitable for treating liquid fluids, air or other gases is provided in accordance with another aspect of the invention. In the fluid treatment system 60, a pump or blower 62 can be used to drive the fluid, such as ambient air, in a linear flow through the inlet 14 to the plurality of concentric chambers 18, and more specifically, to the inner chamber 20c. Then, the fluid can traverse through the length of the inner chamber 20c, providing a first stage or level of fluidic treatment, such as a first treatment for the air. Then, the fluid can be directed to the middle chamber 20b, with the middle chamber 20b receiving the fluid only through holes 30b at a lower portion of the chamber (opposite the inlet 14) in a radial flow that is circumferential relative to the chamber. Then, the fluid can traverse through the length of the middle chamber 20b, providing a second stage or level of fluidic treatment, such as a second treatment for the air. Then, the fluid can be directed to the outer chamber 20a, with the outer chamber 20a receiving the fluid only through holes 30a, at an upper portion of the chamber (opposite the holes 30b) in a radial flow that is circumferential relative to the chamber. Then, the fluid can traverse through the length of the outer chamber 20a, providing a third stage or level of fluidic treatment, such as a third treatment for the air. Finally, from a lower portion of the outer chamber 20a (opposite the holes 30a and the inlet 14), the outer chamber 20a, and the plurality of concentric chambers 18 as a whole, can direct the fluid to the inner cap 22, reversed in orientation relative to FIG. 1, to the outlet 16 in a linear flow. Flow from the outlet 16 may be directed to air handler ducts or directly to the atmosphere. In addition, an inner chamber valve 36c, which may be a relief valve, can be arranged with respect to the inner chamber 20c for selectively releasing fluid from the inner chamber 20c, allowing fluid to bypass the middle and outer chambers 20b and 20a, respectively.

Although the best mode contemplated by the inventors of carrying out the present invention is disclosed above, practice of the above invention is not limited thereto. It will be manifest that various additions, modifications and rearrangements of the features of the present invention may be made without deviating from the spirit and the scope of the underlying inventive concept.

What is claimed is:

1. A fluid treatment system comprising:
a vessel that is defined by a housing and having an inlet, an outlet and a plurality of concentric chambers, each chamber providing a stage of fluidic treatment, wherein the inlet is configured to receive and intake fluid flow and sequentially direct the fluid flow to the plurality of concentric chambers, wherein each chamber of the plurality of concentric chambers is configured to receive the fluid flow in a radial direction that is circumferential relative to the chamber, and wherein the plurality of concentric chambers are configured to direct the fluid toward the outlet of the vessel.

2. The fluid treatment system of claim 1, wherein each chamber is configured to circumferentially receive the fluid flow through holes which form a media retention barrier.

3. The fluid treatment system of claim 2, wherein each chamber is configured to receive the fluid flow only through an upper portion or a lower portion of the respective chamber.

4. The fluid treatment system of claim 1, wherein the plurality of concentric chambers comprises a radially outer chamber, a radially middle chamber, and a radially inner chamber.

5. The fluid treatment system of claim 4, wherein the inlet is configured to direct the fluid flow to the outer chamber, the inner chamber is configured to direct the fluid flow to the outlet, and the outer and middle chambers each comprise a bleeder valve for selectively releasing a portion of the fluid flow.

6. The fluid treatment system of claim 4, wherein the inlet is configured to direct the fluid flow to the inner chamber, the outer chamber is configured to direct the fluid flow to the outlet, and the inner chamber comprises a bleeder valve for selectively releasing the fluid.

7. The fluid treatment system of claim 4, wherein the inner chamber is at least 12 inches in diameter and the outer chamber is at least 24 inches in diameter.

8. The fluid treatment system of claim 1, wherein an outer chamber of the plurality of concentric chambers has a greater radial thickness than an inner chamber of the plurality of concentric chambers.

9. The fluid treatment system of claim 1, further comprising an insulation layer surrounding at least one of the plurality of concentric chambers.

10. The fluid treatment system of claim 1, further comprising an inner cap configured to circumferentially surround the plurality of concentric chambers and distribute the fluid flow from the inlet in more than one radial direction.

11. The fluid treatment system of claim 1, wherein each chamber is configured to treat the fluid flow by providing increasing levels of filtration with each stage.

12. A method of forming a fluid filtration assembly, the method comprising:
providing a vessel with an inlet, an outlet and a plurality of concentric chambers;
forming a fluid flow inlet in the vessel and directing the fluid flow to the plurality of concentric chambers;
directing the fluid flow between each chamber of the plurality of concentric chambers in a radial direction that is circumferential relative to each discrete chamber;
providing a filter stage of fluidic treatment at each chamber; and
directing the fluid flow from at least one of the plurality of concentric chambers to the outlet.

13. The method of claim 12 further comprising placing a beaded filter media in at least one of the plurality of concentric chambers.

14. The method of claim 13 further comprising placing a beaded filter media in each of the plurality of concentric chambers.

15. The method of claim 14 further comprising selecting a beaded filter media from a plurality of beaded filter media's as a function of a characteristic of the fluid flow directed to the inlet.

16. The method of claim 15 further comprising selecting the beaded filter media associated with each of the concentric chambers to treat the fluid flow with different levels of filtration.

17. The method of claim 14 further comprising providing a strainer between adjacent chambers for preventing transmission of the beaded filter media between adjacent chambers of the plurality of concentric chambers with the fluid flow.

18. The method of claim 12 further comprising forming a wall of an outer chamber of the plurality of concentric chambers to have a greater radial thickness than a wall of an inner chamber of the plurality of concentric chambers.

19. The method of claim 12 further comprising insulating at least one of the plurality of concentric chambers.

20. The method of claim 12 further comprising providing an inner cap that is constructed to circumferentially surround the plurality of concentric chambers and direct the fluid flow from the inlet in more than one radial direction.
